(19) United States
(12) Patent Application Publication
(10) Pub. No.: US 2001/0002117 A1
(43) Pub. Date: May 31, 2001

(54) Radiating coaxial high frequency cable

(76) Inventor: Karl Schulze-Buxloh, Monchengladbach (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/725,236

(22) Filed: Nov. 29, 2000

(30) Foreign Application Priority Data
Nov. 30, 1999 (EP) 99403001.3

(51) Int. Cl. H01Q 13/20

(52) U.S. Cl. 333/237; 343/770

(57) ABSTRACT

A radiating coaxial high frequency cable includes an inner conductor, insulation surrounding the same, and a tubular outer conductor which is concentric to the inner conductor and arranged over the insulation. The outer conductor includes openings, which are separated from each other and located in sections, which are arranged in uniform succession in the longitudinal direction of the cable. Each section has at least one first opening and the distance between the first openings of two neighboring sections is equivalent to half the wavelength of a first high frequency to be transmitted. To transmit frequencies, characterized by an integer multiple, without trouble, each section has at least a second opening in the outer conductor, whose distance from the first opening is equivalent to a fourth of the wavelength of the first high frequency to be transmitted.

### BACKGROUND OF THE INVENTION

This application is based on and claims the benefit of European Patent Application No. 99403001.3 filed Nov. 30, 1999, which is incorporated by reference herein.

The invention relates to a radiating coaxial high frequency cable, comprising an inner conductor, insulation surrounding the same, and a tubular outer conductor, which is concentric to the inner conductor and arranged over said insulation. The outer conductor includes openings, which are separated from each other and located in sections arranged in uniform succession in the longitudinal direction of the cable. Each section includes at least one first opening, and the distance between the first openings of two neighboring sections is equivalent to half the wavelength of a first high frequency to be transmitted. See, for example, published German patent application DE 197 38 381 A1.

The openings, called “slots” in the following discussion, that are cut into the outer conductor and control the electromagnetic energy radiating out of the cable, allowing radiating coaxial high frequency cables—hereinafter referred to as “RHF cables,” to be used as antennas, which enable communication between receivers and transmitters that can be moved with respect to each other. One important area of application of RHF cables is the transmission of signals in tunnels between transmitter-receivers and in particular rail-borne vehicles. The RHF cables are also supposed to enable an interference-free operation over longer distances.

Therefore, they are supposed to guarantee low attenuation of the signals to be transmitted and exhibit as few points of reflection as possible. In this respect the attenuation is the sum of the cable attenuation, defined by the RHF cable itself, and the coupling attenuation, generated by the radiation of HF energy.

In order to hold at least approximately constant the received field strength for a receiver moving along the RHF cable, a special configuration of slots in the outer conductor of the RHF cable compensates for the effects of the cable attenuation. This configuration is disclosed in published German patent application DE 41 06 890 A1. The number of slots along the RHF cable increases starting from the HF feeding point in accordance with a specified rule. In the RHF cable according to published European patent application EP 0 643 438 A1, the outer conductor includes successive sections with a varying number of slots. The resulting size of the openings, formed by the slots, increases as the distance from the HF feeding point increases. This feature enables the transmission length of the HF cable to be longer.

The prior art RHF cable, according to the aforementioned DE 197 38 381 A1, is also suitable for higher frequencies while at the same time it retains a long transmission length. In this RHF cable, slots of different sizes are cut into the outer conductor so that the electrically effective size of the openings, formed by the slots, can be further enlarged as the distance from the HF feeding point increases.

In all of the described RHF cables with compensated cable attenuation, the increased transmission length results in higher flexibility in coordinating the respective properties of the transmission system. With the use of such RHF cables, fewer amplifiers or feeding points are needed over the course of the cable route. The configuration and size of the slots in the outer conductor are measured in these RHF cables as a function of the wavelength of the HF—the first HF to be transmitted. If such an RHF cable is also supposed to transmit frequencies that are an integer multiple of the first HF, then interference can lead to noise in the transmission. This applies especially to frequencies, whose ranges differ by a factor of “2.”

### SUMMARY OF THE INVENTION

The invention is based on the problem of improving the RHF cable, described above, so that it can also be used for frequencies that differ by integer multiples—in particular by a factor of 2.

This problem is solved by the invention in that each section includes at least a second slot in the outer conductor, whose distance from the first slot is equivalent to a fourth of the wavelength of the first HF to be transmitted.

By cutting additional slots into each section of the outer conductor of the RHF cable, and in particular at a distance of λ/4 from the first slot, the same can be used without trouble in another frequency range. This also applies especially to frequencies, which are an integer multiple of the frequency, for which the RHF cable is actually laid. The RHF cable can be used, for example, both for the D-network in the 900 MHz range (890-960 MHz) and for the E-network in the 1800 MHz range (1715-1880 MHz). These two frequency ranges differ by a factor of 2.

### BRIEF DESCRIPTION OF THE DRAWINGS

The invention will be more clearly understood from the following description in conjunction with the accompanying drawings, in which,

FIG. 1 is a schematic drawing of a coaxial RHF cable;

FIG. 2 is a schematic, which is in principle well known, for the configuration of slots in the outer conductor of an RHF cable; and

FIG. 3 is a drawing of a configuration of slots in the outer conductor of an RHF cable, according to the invention.

### DETAILED DESCRIPTION OF THE INVENTION

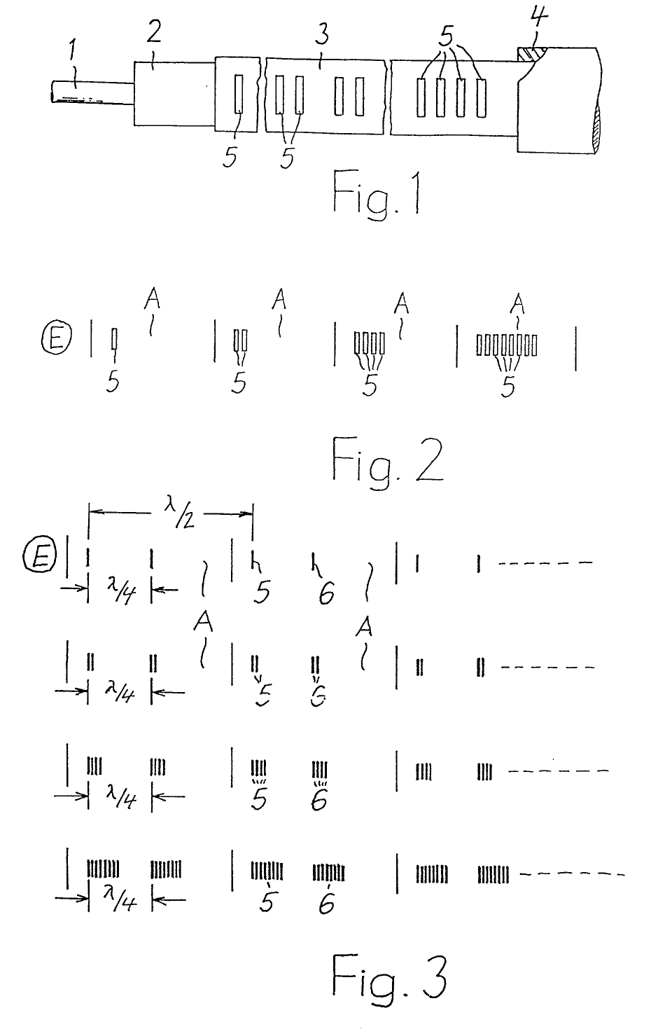

FIG. 1 depicts an RHF cable, which can be laid, for example, between stationary and mobile units in a train tunnel for signal transmission. It has an inner conductor 1, insulation 2 and a tubular outer conductor 3, concentrically enveloping the inner conductor 1. Ase.g., a longitudinal metal strip, the outer conductor 3 is laid around the insulation 3 in such a manner that the edges of the strip overlap. They can be connected together, for example by cementing, soldering or welding. However, the edges of the strip can also be welded together without overlapping. A jacket 4, which is made of plastic and which can also be flame retardant, serves as the outer mechanical shield.

The inner conductor 1 and the outer conductor 3 are made, for example, of copper. The insulation 2 can be made by the conventional method. Thus, it can be solid insulation, which can also be foamed, or hollow core insulation with a spiral or with disks. For the insulation 2, preferably materials having a small dielectric loss factor are used, for example polyethylene. The jacket 4 can be made, for example, of polyethylene or polyvinyl chloride.

The outer conductor 3 includes slots 5, whose length in the circumferential direction in the illustrated embodiment is longer than their axial width. The outer conductor 3 has a plurality of sections A, which lie in uniform succession in the longitudinal direction of the RHF cable. Several sections A having the same number of slots 5 follow directly one behind the other. Due to the slots 5, HF energy can be received outside the RHF cable with a suitable antenna. HF energy can also be transmitted into the RHF cable in the opposite transmission direction.

To ensure that the received signal has an essentially unchanged level along the entire length of the RHF cable, the number of slots per linear unit increases as the distance from the feeding point E of the HF energy increases, as shown in the schematic drawing in FIG. 2 for only one section A. One linear unit of the RHF cable includes all of the sections A with an identical number of slots 5. The axial length of the sections A is a function of the frequency of the HF energy fed into the RHF cable. The higher the frequency, the shorter are the sections A. In all domains of application, the principle design and configuration of the slots 5 should, however, be the same. The number of slots 5 per section A is then increased, when the level of the received signal reaches or exceeds a specified value. Hence, the attenuation between the RHF cable and an antenna, which is moved or is located outside the same, can be kept at a specified value with high accuracy. Such an RHF cable is described, for example, in the aforementioned DE 197 38 381 A1.

As stated above, the outer conductor 3 of the RHF cable includes a large number of sections A in succession with the same number of slots. This number is not increased until the level of the transmitted signals has reached a specified, minimum value. Thus the RHF cable includes, for example, 590 sections A with only one slot 5. The slots 5 are spaced apart in such a manner that half the wavelength is equivalent to the HF to be transmitted (λ/2). This is then followed by, for example, 530 sections A with two slots 5, respectively, 440 sections A with four slots 5, respectively, and 320 sections A with eight slots 5, respectively. Such an RHF cable is, for example 320 m long. It can be used for a specific frequency range—the first HF—for which the spacing between the respective first slots of the sections A is also fixed—without interference and with good efficiency.

In the RHF cable, according to the invention, each section A includes, according to FIG. 3, another slot 6 or a group of slots 6, which is spaced apart from the already existing slot 5 or the respective first slot 5. This distance is equivalent (λ/4) to one fourth of the wavelength of the first HF. Only one other slot 6 is cut at a distance of λ/4 into the sections A with only one slot 5. The sections A with two slots 5 have two additional slots 6, of which the first is spaced a distance of λ/4 from the first slot 5. The sections A with four and eight slots 5 are provided analogously with additional slots 6.

Such an RHF cable is interference-free and can be used with good efficiency also with frequencies that are integer multiples of the first HF, according to which the intervals λ/2 and λ/4 are specified. For example, 565 sections A with two slots, 541 sections A with four slots, 506 sections A with eight slots, and 441 sections A with sixteen slots, are cut in succession in such an RHF cable. The RHF cable is, for example, 350 m long.

What is claimed is:

1. A radiating coaxial high frequency cable, comprising an inner conductor, dielectric surrounding the same, and a tubular outer conductor, which is concentric to the inner conductor and arranged over said dielectric, where the outer conductor includes openings, which are separated from each other and located in sections, which are arranged in uniform succession in the longitudinal direction of the cable, where each section has at least one first opening and the distance between the first openings of two neighboring sections is equivalent to half the wavelength of a first high frequency to be transmitted, characterized in that each section (A) has at least a second opening (6) in the outer conductor (3), whose distance from the first opening (5) is equivalent to a fourth of the wavelength of the first high frequency to be transmitted.
